(19) United States
(12) Patent Application Publication
(10) Pub. No.: US 2014/0239757 A1
(43) Pub. Date: Aug. 28, 2014

(54) Housing Arrangement for an Electrical Machine

(71) Applicant: Cummins Generator Technologies Limited, Stamford (GB)

(72) Inventors: Richard Gray, Sleaford (GB); Martin Christopher Stewart, Peterborough (GB); Gurpreet Saini, Peterborough (GB); Krzysztof Wejrzanowski, Stamford (GB); Christopher Robert Greenham, Peterborough (GB); Andy Hutchinson, Shepshed (GB); Christopher Micallef, Bourne (GB); Duane Jospeh Szymanski, Columbus, IN (US); Michael Green, Stamford (GB); Neil L. Brown, Holbeach (GB); David Shaun Green, Stamford (GB)

(73) Assignee: Cummins Generator Technologies Limited, Stamford, Lincolnshire (GB)

(21) Appl. No.: 14/349,764

(22) PCT Filed: Oct. 18, 2012
(86) PCT No.: PCT/GB2012/000793

§ 371 Date: Apr. 4, 2014

(30) Foreign Application Priority Data
Oct. 18, 2011 (GB) 1117931.4

(51) Int. Cl. H02K 5/22; H02K 11/00; H02K 5/20; H02K 5/16; H02K 15/14; H02K 7/00

(52) U.S. Cl. CPC H02K 5/22; H02K 15/14; H02K 7/006; H02K 5/20; H02K 5/16; H02K 11/0015
USPC 310/58; 29/596; 310/418; 310/75 R; 310/68 B; 310/68 E

(57) ABSTRACT

A motor/generator unit is disclosed which is arranged to be fitted in the drive train of a vehicle, such as a hybrid vehicle. The unit comprises an electrical machine (10, 12) and a housing arrangement (14, 16). The housing arrangement comprises an inner housing (14) arranged to accommodate the electrical machine, and an outer housing (16) arranged to fit around the inner housing. This can allow the electrical machine to be provided as a self-contained unit suitable for use in different applications.

The present invention relates to a housing arrangement for an electrical machine, and in particular an electrical machine arranged for use in the drive train of a vehicle. The invention has particular application in electric and hybrid vehicles, such as cars, trucks and marine vessels.

Hybrid vehicles typically combine an internal combustion engine with an electrical machine. The internal combustion engine and electrical machine are usually arranged such that they can power the vehicle either individually or in combination. The electrical machine can operate either as a motor or a generator. When operating as a motor, electrical energy stored in batteries is used to power the machine. When operating as a generator, the machine can be used to recharge the batteries using mechanical energy derived either from the internal combustion engine, or from regenerative braking.

The electrical machine is usually coupled to the internal combustion engine and to a gear box by means of automatically controlled clutches. For electric driving the clutch between the electrical machine and the internal combustion engine is open, while the clutch to the gear box is engaged. For hybrid driving the clutch between the electrical machine and the internal combustion engine is engaged, and the engine and machine run at the same speed, in the case of a purely electric vehicle the internal combustion engine and associated clutch are omitted, and the vehicle is driven by the electrical machine only.

Electrical machines for hybrid vehicles and electric vehicles are usually custom designed for a specific vehicle. The machine will usually have a housing which retains the stator of the electrical machine, and which interfaces with other components in the drive train. The type and location of the various interfaces are therefore dictated by other components in the vehicle. However, with such an arrangement, it can be difficult to fit the electrical machine to a vehicle which has not been specifically designed for the purpose. For example, it may be difficult to retro-fit the machine to an existing vehicle.

According to one aspect of the present invention there is provided a motor/generator unit arranged to be fitted in the drive train of a vehicle, the unit comprising an electrical machine and a housing arrangement, wherein the housing arrangement comprises an inner housing arranged to accommodate the electrical machine, and an outer housing arranged to fit around the inner housing.

The invention may provide the advantage that, by providing an inner housing arranged to accommodate the electrical machine, and an outer housing arranged to fit around the inner housing, the machine may be provided as a self-contained unit suitable for use in different applications. This may facilitate retro-fitting of the machine to an existing vehicle, or fitting the machine to a vehicle using a standard interface. The present invention may therefore allow a standard unit to be supplied for a variety of different applications, thereby increasing flexibility and achieving economies of scale.

In this context the term “vehicle” may refer to any type of self-propelled mode of transport, such as a land vehicle, a watercraft or an aircraft.

Preferably the inner housing and the outer housing fit together to provide, in combination with the electrical machine, a self-contained motor/generator unit. Preferably the motor/generator unit is totally enclosed. This may facilitate fitting of the unit in different applications and help avoid the ingress of foreign bodies. Any suitable mechanism, such as bolts, may be used to hold the inner and outer housings together.

Preferably the (unassembled) inner housing has an open face. This can facilitate fitting of the electrical machine into the inner housing before the inner housing and outer housing are brought together. The open face of the inner housing is preferably closed by the outer housing in the assembled unit. The outer housing may also have an open face, which may be on the opposite side to the open face of the inner housing. In this case, the inner housing may be inserted into the outer housing through the open face of the outer housing, thereby closing the open face of the outer housing. Preferably the inner housing and outer housing both have open faces and, in the assembled state, the open face of the inner housing is closed by the outer housing and/or vice versa.

The inner housing and/or the outer housing may be substantially cup-shaped. For example, the inner housing and/or the outer housing may comprise a substantially cylindrical wall with an end face which is at least partially closed. However the end face may be open at its centre to allow a shaft to pass through the assembled unit, while ensuring that the electrical machine is fully enclosed. In this case a rotor hub may form the inner surface of the assembled unit.

The inner housing and/or the outer housing may have a substantially cylindrical inner surface. For example, the inner housing and the outer housing may both be generally tubular, preferably with one closed end (that is, substantially cup-shaped). The electrical machine may be located on the inner surface of the inner housing, and the inner housing may be located on the inner surface of the outer housing. Thus it will be appreciated that the inner housing and the outer housing may overlap in a radial direction. This can allow the unit to be formed by sliding the outer housing over the inner housing, thereby facilitating manufacture. For example, the inner housing and the outer housing may overlap by an amount substantially corresponding to the width of the electrical machine, so that the electrical machine is located radially inwards of both a wall of the inner housing and a wall of the outer housing.

Preferably the inner housing is arranged to retain a stator of the electrical machine. The stator is preferably located radially inwards of a wall of the inner housing. This can help to ensure that the stator is firmly secured to the inner housing.

The outer housing may be arranged to interface with other components in the drive train of the vehicle. For example, the outer housing may be arranged to interface with an engine and/or a gearbox, for example, the engine and/or gearbox of a hybrid vehicle. Preferably the outer housing has a standardized interface, such as one prescribed by the Society of Automotive Engineers (SAE), in order to connect to the engine and/or gearbox. Examples of such interfaces are SAE 1 and SAE 2. This can allow the unit to be used in a variety of different applications.

Where the motor/generator unit is to be connected to an engine, the unit may be arranged to be fitted to the same shaft as the engine. A clutch and/or a flywheel or other components may be provided between the engine and the motor/generator unit.

Preferably the main structural strength of the motor/generator unit is provided by the outer housing. Thus the outer housing may be arranged to transfer torque from an engine to a gearbox.

The outer housing may also provide the interface for external components such as electrical terminals for the motor/generator, low voltage terminals for devices such as thermocouples or other sensors, an inlet and outlet for a coolant, and draining points.

Electrical machines often require some form of cooling in order to prevent the machine from overheating. This can be achieved by providing a cooling passage though which a coolant (cooling fluid) can flow. In some existing machines, a cooling passage is provided in the stator housing. For example, EP 1041699 and US 2010/0181873 disclose housing arrangements where a cooling passage is formed through the stator housing. However these arrangements can make the housing difficult to manufacture.

In one embodiment of the present invention, a cooling passage is formed between the inner housing and the outer housing. This can allow the cooling passage to be formed easily by bringing together the inner and the outer housing, rather than requiring a passage to be formed in a solid housing. This arrangement can therefore facilitate manufacturing of the machine.

Cooling may be required in electrical machines for use in many different applications such as marine applications, wind turbines and power generation, and therefore this aspect of the invention may also be provided independently. Thus, according to another aspect of the invention, there is provided a housing arrangement for an electrical machine, the housing arrangement comprising an inner housing arranged to accommodate the electrical machine, and an outer housing arranged to fit around the inner housing, wherein a cooling passage is formed between the inner housing and the outer housing.

The cooling passage may pass circumferentially around the machine. Thus the cooling passage may be formed from a circumferential channel in either the outer surface of the inner housing, or the inner surface of the outer housing, or both. The cooling passage is preferably formed from a single channel, and is preferably located around the centre of the stator, in order to cool the stator at its hottest part. The channel preferably has a width which extends across a substantial part of the width of the stator (for example, at least 50%).

The housing arrangement may further comprise a seal for sealing the cooling passage. The seal may be located on the inner housing, or the outer housing, or both. For example, one or more O rings may be provided for sealing the cooling passage. Preferably an O ring is provided on either side of the cooling passage, in an axial direction. This can allow the coolant to be retained in the cooling passage.

It will therefore be appreciated that a cooling passage may be formed by virtue of the two-part housing assembly. This arrangement can provide advantages in terms of ease of manufacture. However, a potential disadvantage is that a leak could occur between the two parts if a seal should fail.

According to an embodiment of the invention, at least one of the inner housing and the outer housing comprises a groove adjacent to the cooling passage arranged to drain any leakage coolant. The groove may be on the outer surface of the inner housing and/or the inner surface of the outer housing. This can allow a small passage for leakage fluid to be created when the inner and outer housings are brought together. Preferably the groove runs around the circumference of the machine.

If a leak occurs on the side of the cooling passage which is away from the open face of the inner housing, then any leakage coolant will escape to the outside of the machine. Since in this case the coolant will not enter the machine, such a situation may be tolerable. However, if a leak occurs on the same side as the open face of the inner housing, then any leakage coolant could potentially enter the machine, which could be damaging for the machine and/or lead to shorting. Therefore the groove is preferably provided on the same side of the cooling passage (e.g. in an axial direction) as an open face of the inner housing. This may prevent coolant from entering the machine thereby protecting the machine from shorting. Of course, if desired, a groove could be provided on the other side of the cooling passage as well or instead.

Preferably the outer housing comprises a drain hole for draining any leakage coolant from the groove. The housing arrangement may further comprise a one-way valve for draining leakage coolant from the groove. The one-way valve may be in the drain hole or elsewhere. This can prevent the influx of fluids from outside.

In a hybrid vehicle, the electrical machine is usually coupled to a gearbox by means of a clutch. The clutch usually comprises a clutch actuator which forces the plates of the clutch apart in order to open the clutch. Operation of the clutch actuator can therefore result in substantial axial forces being applied to the electrical machine. The electrical machine therefore needs to be able to withstand axial forces resulting from operation of a clutch actuator.

In an embodiment of the invention, the outer housing is arranged to retain a bearing for a rotor of the electrical machine. This can facilitate an arrangement in which the electrical machine is able to withstand axial forces. Furthermore, by arranging the outer housing to retain the bearing, the bearing can be held in place by bringing together the inner and the outer housing. This can facilitate assembly of the machine.

Electrical machines for use in many different applications such as marine applications, wind turbines and power generation may need to withstand axial forces, for example due to operation of a clutch. Therefore this aspect of the invention may also be provided independently. Thus, according to another aspect of the invention, there is provided a housing arrangement for an electrical machine, the housing arrangement comprising an inner housing arranged to accommodate the electrical machine, and an outer housing arranged to fit around the inner housing, wherein the outer housing is arranged to retain a bearing for a rotor of the electrical machine.

Preferably the outer housing is arranged to retain the bearing so as to prevent axial movement of the bearing. This may be achieved by arranging the bearing to be completely constrained. For example, the bearing may be clamped between the outer housing and the rotor. The bearing is preferably able to withstand an axial force resulting from operation of a clutch actuator.

Furthermore, by virtue of the two-part housing assembly, it may be possible to remove the bearing by separating the outer housing from the inner housing. This can allow the bearing to be removed at a later stage for servicing or replacement.

The bearing is preferably contained in a bearing housing, which may comprise an inner race and an outer race. The outer race may be retained by the outer housing, and the inner race may be retained by the rotor. For example, the outer race may be located and held axially by the outer housing to prevent movement. Preferably a bearing cartridge is provided between the outer housing and the bearing, for locating and retaining the bearing. A bearing cap may also be provided, for enclosing the bearing and bearing cartridge. The inner race may be retained, for example, by means of a clip fitted into a groove in the rotor hub, or any other suitable retention means. This can facilitate manufacture, and allow the bearing to be easily removed.

The bearing is preferably located on the same side of the rotor as an open face of the inner housing (e.g. in an axial direction). Where the unit is to be connected to an engine, this may be the non-driven end. This can allow the bearing to be easily retained by the outer housing, which may also function to close the open face of the inner housing. Furthermore, this arrangement may facilitate servicing of the bearing, since the bearing may be accessed by removing the outer housing without the need to remove the rotor or the inner housing.

Preferably a second bearing is provided on the other side of the rotor. The second bearing may be able to move in an axial direction, in order to allow for thermal expansion.

In an alternative arrangement, the motor/generator unit may have a single bearing. This arrangement may help to avoid a shaft through the motor/generator unit being over-constrained. In this case, the shaft may be supported at one end by the motor/generator unit and at the other end by a bearing in another component in the drive train, such as a bearing in an engine flywheel. Where the motor/generator unit is to be connected to an engine, the single bearing may be located at a non-driven end of the unit.

If the motor/generator unit includes a single bearing, the inner housing may comprise a lip which locates a rotating component, such as a rotor hub. This may help to prevent the rotor hub and/or shaft from tilting significantly prior to assembly.

The motor/generator unit may further comprise a seal between a rotating component (such as the rotor hub) and the inner housing. The seal may be used to seal the unit and prevent dust or debris from a clutch or elsewhere from entering the unit. The seal may be a V-seal which may minimise no load losses and may be relatively inexpensive.

The unit may further comprise a resolver for sensing the speed and/or position of a rotor of the electrical machine relative to a stator. Where the motor/generator unit is arranged to be connected to an engine, the resolver may be located at a non-driven end of the unit. This may facilitate servicing of the resolver.

According to another aspect of the invention there is provided a vehicle drive train comprising a motor/generator unit in any of the forms described above.

Corresponding methods may also be provided. Thus, according to another aspect of the invention, there is provided a method of assembling a motor/generator unit, the method comprising: fitting an electrical machine in an inner housing, and fitting an outer housing around the inner housing, thereby to provide a self-contained motor/generator unit; and fitting the motor/generator unit to the drive train of a vehicle.

Features of one aspect of the invention may be applied to any other aspect. Any of the apparatus features may be provided as method features and vice versa.

In the present specification, terms such as “axial”, “radial” etc. are generally used with reference to the axis of rotation of the electrical machine.

Preferred embodiments of the invention will now be described, purely by way of example, with reference to the accompanying drawings, in which:

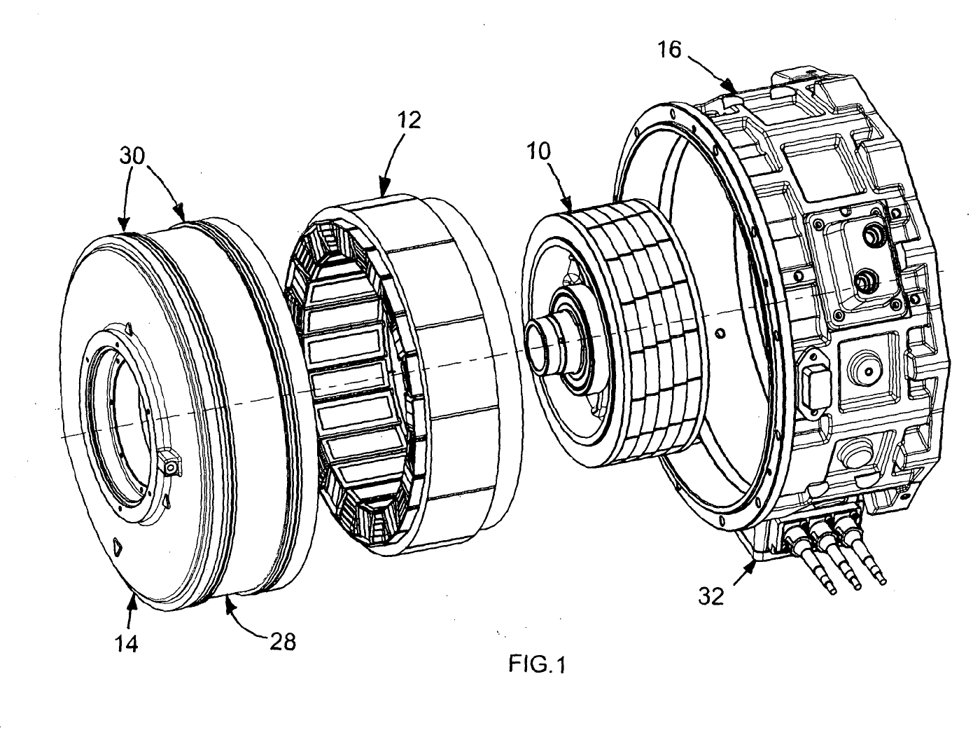

FIG. 1 is an exploded view showing parts of a motor/generator unit in an embodiment of the invention;

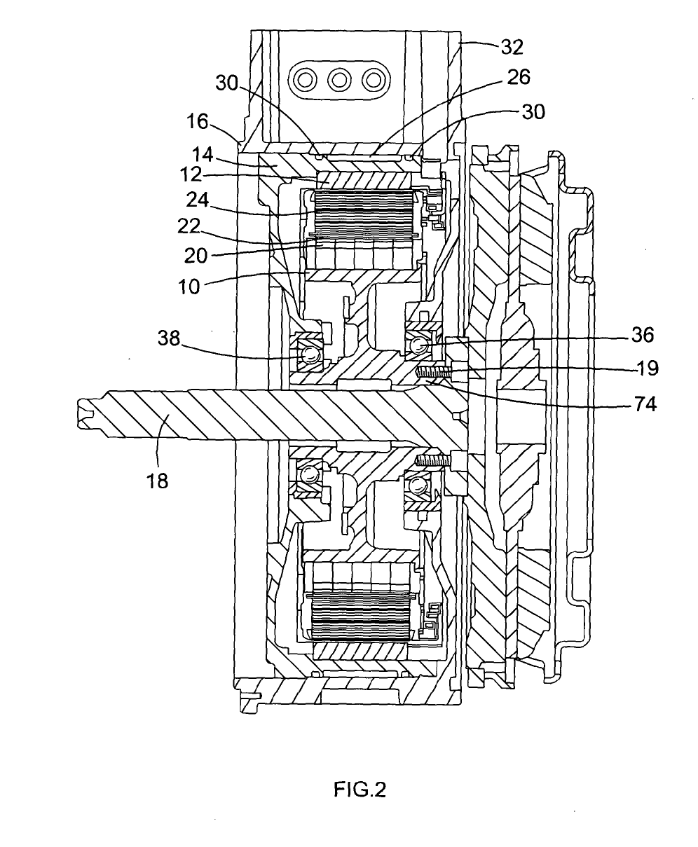

FIG. 2 is a cross-section through the assembled unit;

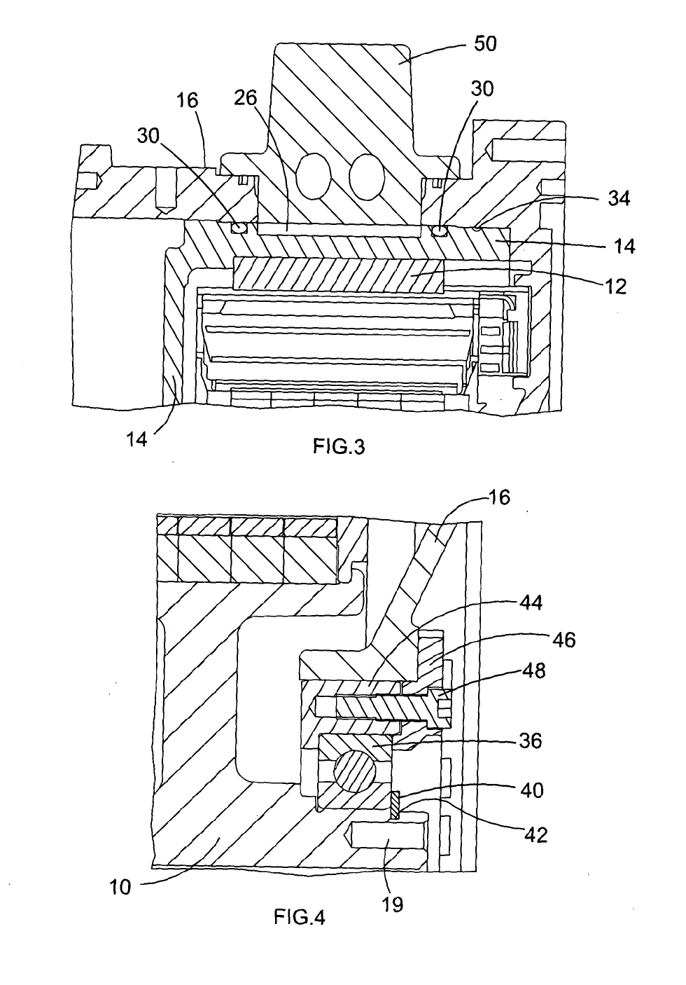

FIG. 3 is a partial cross-section showing a cooling channel in more detail;

FIG. 4 is a partial cross-section showing a bearing in more detail;

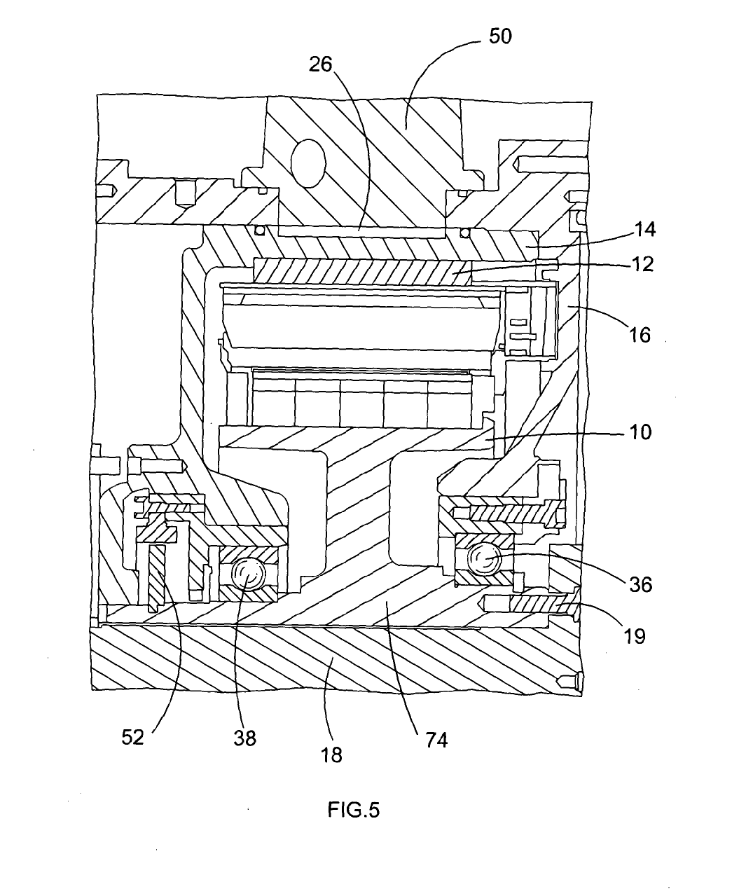

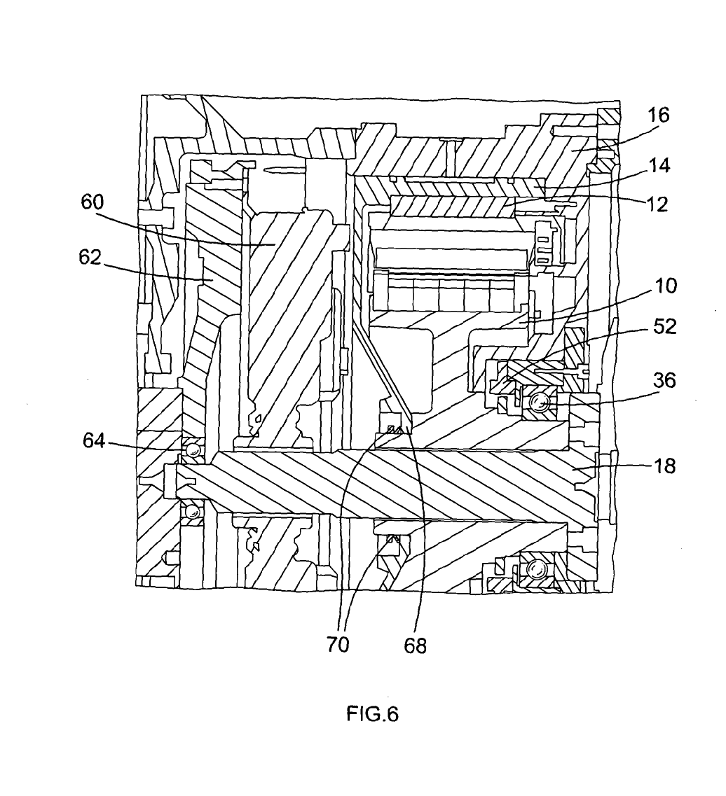

FIG. 5 is a cross section through part of a motor/generator unit in another embodiment;

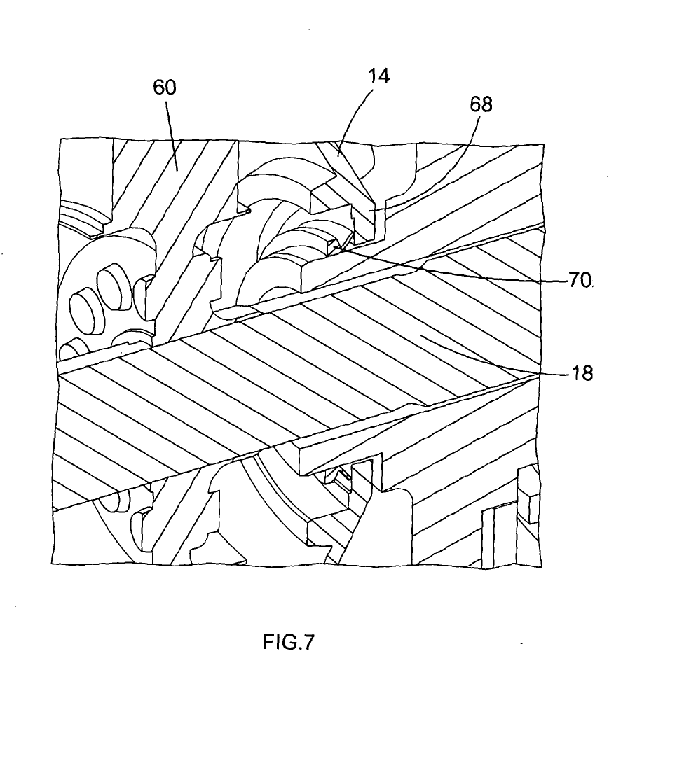

FIG. 6 is a cross section through part of a motor/generator unit in a further embodiment; and

FIG. 7 shows a detail of the motor/generator unit of FIG. 6.

FIG. 1 is an exploded view showing parts of a motor/generator unit in an embodiment of the invention. Referring to FIG. 1, the unit includes an electrical machine comprising rotor 10 and stator 12. A two-part housing arrangement consisting of inner housing 14 and outer housing 16 is arranged to fit around the electrical machine. The inner housing and outer housing are both cup-shaped, with their open ends facing in opposite directions. The inner housing 14 and outer housing 16 are preferably cast and/or machined from metal.

FIG. 2 shows a cross-section through the assembled unit. Referring to FIG. 2, the rotor 10 is mounted on a shaft 18, and is secured thereto by means of bolts 19 in the rotor hub 74. Bearings 36, 38 are provided on either side of the rotor 10, in order to allow the rotor and the shaft 18 to rotate freely. The rotor 10 is located radially inwards of the stator 12. The stator 12 is retained on the inside of the inner housing (stator housing) 14. The inner housing itself is located radially inwards of the outer housing 16. Thus, in the assembled unit, the rotor 10 and stator 12 are enclosed by the combination of the inner housing 14 and outer housing 16. The inside surface of the assembled unit is formed from the rotor hub 74.

The rotor 10 includes a number of permanent magnets 20. Magnetic flux produced by the permanent magnets 20 crosses an air gap 22 between the rotor 10 and the stator 12, and combines with stator windings 24. In the case of generator operation, an engine (not shown) mounted on the shaft 18 causes the rotor 10 to rotate, thereby generating an electrical output in the stator windings 24. In the case of motor operation, a commutated electrical current is supplied to the stator windings, which causes the rotor to rotate. A terminal box 32 provides the electrical connections to the stator windings.

The motor/generator unit shown in FIGS. 1 and 2 is designed to be placed between the engine and gearbox of a hybrid vehicle, such as a commercial road vehicle. The engine, together with a fly wheel and a dutch, are fitted to the shaft 18 on the left hand side of FIG. 2, while the gearbox and a further dutch are fitted on the right hand side of FIG. 2. A standard bolt pattern fitment, such as SAE 1 or SAE 2, may be provided for this purpose. The outer housing 16 is designed to be structurally sound and to carry the through torque from the engine to the gearbox, as well as to interface with external components. This arrangement can allow the electrical machine to be supplied as a self-contained unit suitable for use in different traction applications. For example, the unit may be retro-fitted to an existing vehicle, or fitted to a new vehicle using a standard interface. This can allow a standard machine to be supplied for a variety of different applications.

Referring again to FIG. 2, a cooling passage 26 is formed through the inside of the assembled housing. The cooling passage 26 is created by forming a channel 28 on the outer surface of the inner housing 14, as shown in FIG. 1. When the inner housing 14 and outer housing 16 are brought together, the channel 28 creates a gap between the housings, thereby creating cooling passage 26. The cooling passage 26 is used to carry a coolant around the outside of the machine.

The inner housing 14 has O-rings 30 fitted to its outer circumference at two locations. The O-rings 30 coincide with grooves on the inner surface of the outer housing 16. The O-rings thus function to seal the cooling passage 26 when the inner housing 14 and the outer housing 16 are brought together. The cooling passage 26 can thus be formed by virtue of the two-part housing arrangement, thereby simplifying manufacture. An inlet and outlet (not shown) are provided for carrying coolant into and out of the cooling passage 26.

The motor/generator unit described above is a totally enclosed unit, with a cooling passage formed by virtue of the two-part housing assembly. The O-rings 30 are used to seal the cooling passage 26. However, if one of the O-rings should fail, there is a chance that coolant could leak out between the inner housing and the outer housing. If the leak occurs in the left-hand O-ring of FIG. 2, then the leakage coolant will escape to the outside of the machine. However, if the leak occurs in the right-hand O-ring, then the leakage coolant will enter the machine, which could lead to damage and a short circuit.

FIG. 3 is a cross-section through another part of the motor/generator unit, showing the area around the cooling passage 26 in more detail. Referring to FIG. 3, a manifold 50 is used to carry coolant into and out of the cooling passage 26. A groove 34 is provided on the outside surface of the inner housing 14. The groove 34 runs circumferentially around S the machine. If the right hand O-ring 30 should fail, then any leakage coolant will enter into the groove 34. A drain hole with a one-way valve (not visible in FIG. 3) is provided at the bottom of the outer housing 16, in order to drain away any leakage coolant. This arrangement can therefore function to prevent any leakage coolant from entering the machine.

The motor/generator unit described above is designed to be placed between the engine and gearbox of a hybrid vehicle. In such an arrangement, the electrical machine is usually coupled to the gearbox by means of a clutch, to allow disengagement of the machine. However, operation of the clutch actuator can result in substantial axial forces being applied to the electrical machine.

FIG. 4 shows the area around the bearing 36 of FIG. 2 in more detail. The bearing 36 is provided to allow to rotor 10 to rotate inside of the stator and housing arrangement. As can be seen from FIG. 4, the bearing comprises an inner race and an outer race. The inner race is located on the rotor, and is held in place by a circlip 40 which is fitted into a groove 42 in the rotor hub. The outer race is held in place by the outer housing 16, using a bearing cartridge 44 and bearing cap 46. A bolt 48 holds the assembly together.

In the arrangement of FIG. 4, the bearing cartridge 44 and cap 46 are designed such that the outer race of the bearing is located and held axially to prevent movement. This can allow the motor/generator unit to withstand axial forces applied by the operation of a clutch actuator. By contrast, the bearing 38 shown on the left hand side of FIG. 2 is allowed some axial movement, in order to allow for thermal expansion.

During manufacture of the motor/generator unit, the stator 12 is inserted in the inner housing 14 with a shrink fit. O-rings are fitted to the outer surface of the inner housing in two places to coincide with two sealing diameters on the inner bore of the outer housing 16. The rotor unit is assembled into the inner housing and locates onto the inner housing bearing 38. The inner housing 14 together with the rotor and stator assembly and outer housing bearing 36 is then pressed gently into the outer housing 16. The act of doing so not only retains the rotor in its final location between the two bearings, but also positions the O-ring seals 30 and forms the cooling passage 26.

Thus, by using two cup-shaped housings, where the open end of one housing slips into the other, the rotor is retained and located whilst at the same time the cooling passage is formed and sealed. Furthermore, the two-part housing arrangement allows the bearing 36 to be removed by separating the outer housing from the inner housing. This can allow the bearing to be taken out at a later stage for servicing or replacement if necessary.

FIG. 5 is a cross section through part of a motor/generator unit in another embodiment. Parts which are in common with the previously-described embodiments are given the same reference numerals, and are not described further.

In the embodiment of FIG. 5, the motor/generator unit includes a resolver 52. The resolver is sensor which measures the speed and position of the rotor relative to the stator. In this embodiment the resolver 52 is a brushless transmitter resolver of a type known in the art. Speed and position measurements obtained by the resolver are fed through a low voltage connector on the outside of the housing arrangement to a control unit which controls the operation of the electrical machine. The resolver 52 is clamped in position between the inner housing 14 and the rotor hub 74. The resolver 52 is a pre-production unit in order to help reduce cost.

In the embodiments described above, the motor/generator unit is provided as a stand alone unit with its own bearing on each side of the unit. This can allow the unit to be used in a wide variety of different applications. However, in certain circumstances it has been found that the two-bearing arrangement can result in the shaft being over-constrained when the unit is coupled to other components.

FIG. 6 is a cross section through part of a motor/generator unit in another embodiment.

Parts which are in common with the previously-described embodiments are given the same reference numerals, and are not described further. In the embodiment of FIG. 6, a one-bearing arrangement is used rather than the two-bearing arrangement of previously-described embodiments.

In FIG. 6, the motor/generator unit is shown coupled to a clutch 60 and an engine fly-wheel 62. The motor/generator unit, clutch and fly-wheel are all located on shaft 18. The shaft is supported on one side by the rotor hub and on the other side by bearings 64 in the flywheel 62. Thus the bearings 36 on the rotor hub support the shaft on one side, while on the other side the shaft is supported by bearings 64 in the engine flywheel. This arrangement can allow a single bearing to be used in the motor/generator unit.

FIG. 7 shows the area around the shaft and the inner housing in more detail. Referring to FIGS. 6 and 7, the inner housing 14 has a lip 68 which locates the rotor hub with a clearance of about 0.5 mm. This can prevent the shaft from tilting significantly prior to assembly. A seal 70 is used to seal the unit and prevent dust or debris from the clutch or elsewhere from entering the unit. In this embodiment the seal is a V-seal which minimises no load losses and is relatively inexpensive.

In the arrangement of FIG. 6, the resolver 52 is located adjacent to the bearings 36. By moving the resolver to the transmission side of the motor/generator unit, servicing of the resolver can be simplified as the electrical machine can remain on the engine during servicing, and the resolver rotor no longer needs to be removed during regular strip down/service.

The arrangement of FIG. 6 can help address system alignment issues, by providing bearings on one side of the motor/generator unit only. Flywheel bearings provide support for the shaft on the engine side. This arrangement can allow the overall length of the motor/generator unit to be reduced, and can allow cost savings to be achieved through the use of few components.

While preferred embodiments of the invention have been described with reference to particular examples, it will be appreciated that variations of detail are possible within the scope of the invention. Although embodiments have been described with reference to an electrical machine for use in a hybrid vehicle, the invention may be applied to a purely electric vehicle, and may be used in various different applications such as marine applications and automotive applications. The electrical machine may be powered by batteries, fuel cells, or any other source of electrical energy and/or by a prime mover such as an engine.

1-37. (canceled)

38. A motor/generator unit arranged to be fitted in the drive train of a vehicle, the unit comprising an electrical machine and a housing arrangement, wherein the housing arrangement comprises an inner housing arranged to accommodate the electrical machine, and an outer housing arranged to fit around the inner housing.

39. A unit according to claim 38, wherein the inner housing and the outer housing fit together to provide a self-contained, totally-enclosed motor/generator unit.

40. A unit according to claim 38, wherein the inner housing and outer housing both have open faces and, in the assembled state, the open face of the inner housing is closed by the outer housing and vice versa.

41. A unit according to claim 38, wherein the inner housing and the outer housing are substantially cup-shaped.

42. A unit according to claim 38, wherein the inner housing and the outer housing have a substantially cylindrical inner surface.

43. A unit according to claim 38, wherein the electrical machine is located on the inner surface of the inner housing, and the inner housing is located on the inner surface of the outer housing.

44. A unit according to claim 38, wherein the outer housing is arranged to slide over the inner housing.

45. A unit according to claim 38, wherein the inner housing retains a stator of the electrical machine.

46. A unit according to claim 38, wherein the outer housing is arranged to interface with other components in the drive train of the vehicle.

47. A unit according to claim 38, wherein the outer housing is arranged to interface with at least one of an engine and a gearbox.

48. A unit according to claim 38, wherein the unit is arranged to be fitted to the same shaft as an engine.

49. A unit according to claim 38, wherein the outer housing is arranged to transfer torque from an engine to a gearbox.

50. A unit according to claim 38, wherein the outer housing provides an interface for external components.

51. A unit according to claim 38, wherein a cooling passage is formed between the inner housing and the outer housing.

52. A unit according to claim 51, wherein the cooling passage passes circumferentially around the machine.

53. A unit according to claim 51, wherein the cooling passage is formed from a circumferential channel in at least one of the outer surface of the inner housing and the inner surface of the outer housing.

54. A unit according to claim 51, further comprising a seal which seals the cooling passage.

55. A unit according to claim 51, wherein an O-ring is provided on either side of the cooling passage.

56. A unit according to claim 51, wherein at least one of the inner housing and the outer housing comprises a groove adjacent to the cooling passage arranged to drain any leakage coolant.

57. A unit according to claim 38, wherein the outer housing retains a bearing for a rotor of the electrical machine.

58. A unit according to claim 57, wherein the outer housing is arranged to retain the bearing so as to prevent axial movement of the bearing.

59. A unit according to claim 57, wherein the bearing is completely constrained.

60. A unit according to claim 57, wherein the bearing is clamped between the outer housing and the rotor.

61. A unit according to claim 57, wherein the bearing is arranged to withstand an axial force resulting from operation of a clutch actuator.

62. A unit according to claim 57, wherein the bearing can be removed by separating the outer housing from the inner housing.

63. A unit according to claim 57, wherein the bearing is located on the same side of the rotor as an open face of the inner housing.

64. A unit according to claim 57, wherein the bearing is contained in a bearing housing comprising an inner race and an outer race, and wherein the outer race is retained by the outer housing, and the inner race is retained by the rotor.

65. A unit according to claim 57, further comprising a bearing cartridge between the outer housing and the bearing.

66. A unit according to claim 57, wherein a second bearing is provided on the other side of the rotor.

67. A unit according to claim 66, wherein the second bearing can move in an axial direction.

68. A unit according to claim 57, wherein the unit has a single bearing.

69. A unit according to claim 68, wherein the inner housing comprises a lip which locates a rotating component.

70. A unit according to claim 68, further comprising a seal between a rotating component and the inner housing.

71. A unit according to claim 38, further comprising a resolver for sensing at least one of the speed and the position of a rotor of the electrical machine relative to a stator.

72. A unit according to claim 71, wherein the motor/generator unit is arranged to be connected to an engine, and the resolver is located at a non-driven end of the unit.

73. A vehicle drive train comprising a motor/generator unit, the motor/generator unit comprising an electrical machine and a housing arrangement, wherein the housing arrangement comprises an inner housing arranged to accommodate the electrical machine, and an outer housing arranged to fit around the inner housing.

74. A method of assembling a motor/generator unit, the method comprising:
fitting an electrical machine in an inner housing, and fitting an outer housing around the inner housing, thereby to provide a self-contained motor/generator unit; and
fitting the motor/generator unit to the drive train of a vehicle.
